(19) United States
(12) Patent Application Publication
(10) Pub. No.: US 2009/0081154 A1
(43) Pub. Date: Mar. 26, 2009

(54) Attractant composition for yellowjackets

(76) Inventor: William C. Hiscox, Spokane Valley, WA (US)

Correspondence Address: William C. Hiscox, P.O. Box 1228, Pullman, WA, 99163, US

(21) Appl. No.: 11/818,637

(22) Filed: Jun. 15, 2007

Related U.S. Application Data
(60) Provisional application No. 60/814,262, filed on Jun. 15, 2006.

(51) Int. Cl. A01N 47/02

(52) U.S. Cl. 424/84; 514/506

(57) ABSTRACT

Disclosed is a new attractant composition for yellowjacket wasps, which contains certain esters of butyric acid known to be attractive to yellowjackets, such as heptyl butyrate, octyl butyrate, or other esters of butyric acid, in combination with certain plant volatiles (kairomones), including trans-2-hexenol and methyl salicylate, said kairomones being used in combination with said esters of butyric acid to achieve an enhanced or synergistic attractiveness to yellowjackets. The new attractant composition is significantly more attractive to yellowjackets than the known attractant esters heptyl butyrate and octyl butyrate when used either singly or together.

### CROSS-REFERENCE TO RELATED APPLICATIONS

This application claims priority of U.S. Provisional Patent Application No. 60-814262, Attractant Composition for Yellowjackets.

### FIELD OF THE INVENTION

The present invention relates to chemical attractants for insects, and more specifically to attractants for yellowjacket wasps (Vespula species), and comprises compositions of multiple attractants for yellowjackets.

### BACKGROUND OF THE INVENTION

When under attack by herbivorous insects, plants respond by emitting certain volatile compounds (kairomones) that act in part to draw predators to the vicinity of the damage. Such predators use the information from these volatile mixtures to find prey (Dicke, M., Van Beek, T. A., Posthumus, M. A., Ben Dom, N., Van Bokhoven, H., and De Groot, A. E. J. Chem. Ecol. 1990, 16:381-396.; Turlings, T. C. J., Tumlinson, J. H., and Lewis, W. J. Science 1990, 30:1251-1253.; Vet, L. E. M. and Dicke, M. Annu. Rev. Entomol. 1992, 37:141-172; Paré, P. W. and Tumlinson, J. H. Nature 1997, 385:30-31; Scutareanu, P., Drukker, B., Bruin, J., Posthumus, M. A., and Sabelis, M. W. J. Chem. Ecol. 1997, 23:2241-2260; Drukker, B., Bruin, J., Jacobs, G., Kroon, A., and Sabelis, M. W. Exp. Appl. Acarol. 2000, 24:881-895). De Boer and company (De Boer, J. G.; Posthumus, M. A.; Dicke, M., J. Chem. Ecol., Vol. 30, No. 11, November 2004) describe the ability of the predatory mite Phytoseiulus persimilis to sense certain lima bean volatiles, including methyl salicylate and (3E, 7E)-4,8,12-trimethyl-1,3,7,11-tridecatetraene, emitted as a result of damage caused by herbivorous insects. The presence of these volatiles enables persimilis to locate herbivorous prey. Attractiveness of methyl salicylate to persimilis was confirmed by Y-tube olfactometer studies. James and Price (D. G. James and T. S. Price, J. Chem. Ecol., 2004, 30:8, 1613-1628) have shown that methyl salicylate is effective in the recruitment and retention of beneficial predators for the protection of grapes and hops. In experiments conducted in juice grape vineyards, methyl salicylate baited plots were shown to contain significantly greater numbers of five predatory insects (Chrysopa nigricornis, Hemerobius sp., Deraeocoris brevis, Stethorus punctum picipes, and Orius tristicolor), and in hop yard experiments methyl salicylate baited yards contained many more beneficial predators (four times as many S. punctum picipes and six times as many O. tristicolor) than unbaited yards. Green leaf volatiles, including 1-hexanol, trans-2-hexen-1-ol, cis-3-hexen-1-ol and their corresponding aldehydes are produced by plants via oxidation of plant lipids (Visser et al., J. Chem. Ecol. 1979, 5, 13, and references cited therein). Dickens reports in U.S. Pat. No. 6,413,508 a synergistic effect of green leaf volatiles with insect-specific pheromones on boll weevils, European elm bark beetles, and Mediterranean fruit flies. Among these plant volatiles, trans-2-hexen-1-ol, hexanal, trans-2-hexenal, cis-3-hexen-1-ol, and 1-hexanol were found to be most effective. I have now found that certain kairomones, especially methyl salicylate and trans-2-hexenol enhance the attractiveness of a general class of known yellowjacket attractants (exemplified by heptyl butyrate and octyl butyrate) to yellowjackets.

Chemical compositions for the attraction of yellowjackets (genus Vespula) have been the subject of recent patent activity, due to their economic importance as pests in areas frequented by people. Yellowjackets are beneficial insects, and are predators of garden pests, such as aphids, thrips, whiteflies, caterpillars and many other small prey species. They have an important role in the natural regulation of these economically more important pest species, as such species cause great damage to crops and personal gardens. Knowledge of the foraging habits of yellowjackets, and proper precautions to avoid conflicts with them, can prevent most negative encounters. Nonetheless, yellowjackets may not only become a nuisance to picnickers, golfers and homeowners, but are capable of stinging repeatedly without harm to the insect. They may swarm when attacking. Their venom is a powerful neurotoxin, and allergic response in humans can be fatal in some cases. In any case, a negative encounter with a single yellowjacket can be a painful experience. Several notable recent events have had wide news coverage, where swarms of yellowjackets attacked a victim after the victim had inadvertently disturbed a nest. In several of these cases, the victim died as a result of the attack. Thus, there is a valid need for effective means of control of yellowjackets. One type of control strategy is mass trapping of worker yellowjackets. When a suitable attractant or lure is presented inside of a trap, workers will enter the trap to find the source of the attractant odor, which presumably is indicative of a desirable food source inside of the trap. Attractants and lures may also be used in conjunction with bait stations, where poisonous bait is to be distributed to foraging yellowjackets, which repeatedly take bait back to the nest, thus eventually killing the nest.

Previously disclosed yellowjacket attractants are numerous, and include foodstuffs and beverages, as well as chemical attractants. Chemical attractants include the widely used ester heptyl butyrate, which is one of a number of butyric acid esters capable of attracting western yellowjackets (Vespula pensylvanica). Esters capable of attracting western yellowjackets are thought to be relatively ineffective at attracting yellowjacket species in the eastern United States, including Vespula maculifrons (eastern yellowjacket) and Vespula germanica (German yellowjacket). Heptyl butyrate, however, has been found to attract high numbers of Vespula vidua, a common yellowjacket of the Eastern North American continent, as well as V. germanica in some geographic areas, especially in the western U.S., and several other species across North America, including V. atropilosa and V. Sulphurea (and to some extent, V. vulgaris) in the western U. S., and V. flavopilosa and V. squamosa in the Midwest and southeast.

Many single-component attractants for yellowjackets have been reported. Eddy et al. (U.S. Pat. No. 3,912,810) describe a method of attracting yellowjackets using an ester having an alcohol and an acid moiety and having a chain length of from 10 to 12 carbon atoms. 2,4-Hexadienyl butyrate, 2,4-hexadienyl propionate and 2,4-hexadienyl isobutyrate were shown to attract V. pensylvanica (Davis et al. 1967, J. Med. Entomol. vol. 4, pp. 275-280). Heptyl butyrate (Davis et al. 1969, J. Econ. Entomol. vol. 62, p. 1245; Davis et al. 1973, Environmental Entomol. vol. 2, pp. 569-571; MacDonald et al. 1973, Environmental Entomol. vol. 2, pp. 375-379) and octyl butyrate (Davis et al. 1972, Environmental Entomol. vol. 1, p. 673; McGovern et al. 1970, J. Econ. Entomol. vol. 63, pp. 1534-1536) have also been shown to be effective attractants for yellowjackets.

Landolt (Landolt, P. J., 1998, Environmental Entomol. vol. 27, no. 4; Landolt, P. J., U.S. Pat. No. 6,083,498, 2000) discloses compositions of vapor blends of acetic acid and one or more of isobutanol, racemic 2-methyl-1-butanol, S-(−)-2-methyl-1-butanol, 2-methyl-2-propanol, heptyl butyrate and butyl butyrate as yellowjacket attractants for multiple species.

Aldrich et al. (Aldrich et al., Experientia 1986, vol. 42, pp. 583-585) described the use of spined soldier bug pheromone for attraction of eastern yellowjackets (and related species) workers and queens. The compositions of attractants are similar to those used for attraction of soldier bugs, and are a mixture of (E)-2-hexenal with either alpha.-terpineol or linalool.

Aldrich, Jeffrey R. (U.S. patent application No.20030109581) later discloses a combination of attractants based on the Landolt formula plus the pheromone of the soldier bug, trans-2-hexenal in combination with alpha-terpineol or linalool. A synergistic effect was found between the so-called H/T/B formula and Landolt's IB/AA for Vespula maculifrons (Eastern yellowjacket), and in one case for V. germanica (German yellowjacket), with respect to the individual components H/TB or IB/AA. However, the synergistic effect seems to be limited to V. maculifrons and V. germanica species. It is apparent from the data that a synergistic effect between H/T/B and heptyl butyrate may be possible for V. maculifrons. One claim in the Aldrich application includes heptyl butyrate as part of a list of compounds under the heading “Component B”, where Component A consists of trans-2-hexenal—or derivative thereof—and linalool or alpha-terpineol, where Components A and B are to be used in combination.

The attractant formulas described in the Landolt and Aldrich patents have several potential problems. For example, acetic acid cannot be easily or safely packaged, since it is vigorously acidic, and is chemically incompatible with many packaging materials; thus, it can only be used in dilute solution. Also, trans-2-hexenal, a key component of the Aldrich lure, has an objectionable smell to humans, other animals and insects, and becomes repellant at moderate concentrations. In fact, trans-2-hexenal-usually in combination with other volatiles-is employed as a defense against predators by several prey species, which emit the chemical as a spray or secretion when disturbed (Krall, B. S., Bartelt, R. J., Lewis, C. J. and Whitman, D. W., J. Chem. Ecol. 1999, 25:11, 2477-2494; Staddon, B. W., Adv. Insect Physiol. 1979, 14, 351-418; and references cited therein). The H/T/B-IB/AA formula disclosed by Aldrich was not tested in the presence of Western yellowjackets (V. pensylvanica), prairie yellowjackets (V. atropilosa), species of common yellowjackets (V. vulgaris group), or V. vidua (Northeastern U.S.—similar in foraging habits and preferences to V. pensylvanica), so no data exists to indicate its usefulness in luring yellowjackets other than V. maculifrons and V. germanica in most of the North American continent.

Thus, there remains a need for a new chemical attractant, or combination of attractants, that outperforms heptyl butyrate or compositions including heptyl butyrate for attracting yellowjackets to a trap or bait station. A need remains for a chemical attractant composition which is more attractive to yellowjackets than currently available chemical attractants. The present invention addresses this need.

### SUMMARY OF INVENTION

The invention is a chemical composition which is highly attractive to yellowjackets. The major components of the attractant combination are heptyl butyrate and/or octyl butyrate, both known attractants for yellowjackets. The minor components of the composition are trans-2-hexen-1-ol (t-2-H) and methyl salicylate (MSA). I have found that the use of t-2-H and MSA mixed with either heptyl or octyl butyrate, or a combination of the two esters, is more attractive to Vespula pensylvanica than the esters by themselves.

trans-2-Hexenol (alternative names are (E)-2-hexen-1-ol, (E)-2-hexenol, trans-2-hexen-1-ol) is released when a plant sustains damage due to feeding herbivores. Plants release certain chemicals when injured or attacked by herbivorous insects, it is believed, in order to draw predators of the herbivores into the area, and may also release chemicals to warn other plants of an attack. While this latter function of plants is still a matter of debate, the former role of some plant volatiles in signaling to predators has now been well established.

I have evidence that synthetic trans-2-hexenol, when combined with heptyl or octyl butyrate, is more attractive to yellowjacket wasps than heptyl or octyl butyrate alone. The effect has been demonstrated for octyl butyrate and heptyl butyrate, and also for combinations of the two esters.

Methyl salicylate is another plant volatile known to be released by plants under stress of leaf damage or insect feeding on the plants. A recent study by De Boer and company showed that the release of MSA (and other volatiles) by plants is responsible for drawing the predatory mite Phytoseiulus persimilis to the vicinity of the damage (De Boer, J. G.; Posthumus, M. A.; Dicke, M., J. Chem. Ecol., Vol. 30, No. 11, November 2004 and references cited therein). Synthetic MSA was also shown to be attractive to persimilis by Y-tube olfactometer studies performed by the De Boer group. I have now found that methyl salicylate significantly enhances the attractiveness of butyric acid esters known to be attractive to yellowjackets, including heptyl butyrate and octyl butyrate.

I have also found that combinations of MSA and trans-2-hexenol in heptyl or octyl butyrate is more attractive to yellowjackets than either of the two esters alone. Preliminary testing of MSA with heptyl butyrate showed increased attractiveness over heptyl butyrate alone. More substantial and prolonged testing was performed with MSA and t-2-H in octyl butyrate, and in heptyl butyrate/octyl butyrate mixtures. It is anticipated that the synergistic effect I have discovered between the kairomones methyl salicylate and/or trans-2-hexenol and known yellowjacket attractants heptyl and/or octyl butyrate, will hold for any of a large number of butyric acid esters known to be attractive to yellowjackets.

### DETAILED DESCRIPTION OF THE INVENTION

The invention is an attractant for yellowjacket wasps and other insects. The invention provides enhancement of attractancy of esters such as heptyl butyrate (HB) or octyl butyrate (OB) to yellowjackets, when either or both of the kairomones methyl salicylate (MSA) and trans-2-hexen-1-ol (alternative names trans-2-hexenol and (E)-2-hexenol, abbreviated t-2-H in this account) are added to the ester(s). The addition of these kairomones to the esters results in higher catches of yellowjackets in baited traps, when compared to the esters alone. The invention is anticipated to be general to any of the large group of esters known to be attractive to yellowjackets (see Davis 1969, 1972, 1973; Eddy 1975; MacDonald 1973; and McGovern 1970, and references cited therein). For this discussion, these known attractant esters will be referred to by the generic terms “esters of butyric acid”, or simply “esters”. The invention works with single esters, or with combinations of esters, such as the combination of heptyl butyrate and octyl butyrate.

The combination of heptyl butyrate and octyl butyrate was tested extensively to determine the relative efficacy when tested against either single ester. While heptyl butyrate was found to be more effective in luring and capturing yellowjackets than octyl butyrate, the combination of the two was found to be more attractive than either of the single esters, thus revealing a synergistic effect. In the most preferred embodiment of the invention, a combination of heptyl butyrate and octyl butyrate is treated with between 0.5% and 10% of each of the kairomones methyl salicylate and trans-2-hexenol. The presence of both kairomones is not necessary to achieve an enhanced effect, and other embodiments of the invention employ either methyl salicylate or trans-2-hexenol in combination with an ester or esters of butyric acid.

The invention functions in the following way. The ester (butyric acid ester) by itself is attractive to numerous species of yellowjackets. Methyl salicylate (MSA) is a known kairomone, which is emitted by certain plants having sustained leaf or vegetative damage. MSA has been shown to be responsible for attracting predators to the site of the leaf damage. Synthetic MSA has also been reported to attract certain non-wasp predators. It is also known that trans-2-hexenol, a component of the volatiles released from damaged plants, is attractive to non-wasp predators.

Many insect prey species preyed upon by yellowjackets are herbivorous leaf or vegetable eating insects, which cause leaf damage. Although it has been known for some time that several carnivorous non-wasp predators are attracted by the various plant volatiles emitted by herbivore-damaged plants, this has not previously been observed for yellowjackets. This is the first report that two of these plant volatiles, methyl salicylate and trans-2-hexenol, are also attractive to yellowjackets. In combination with the known yellowjacket attractants heptyl butyrate and octyl butyrate, the kairomones MSA and t-2-H provide enhanced attractancy over the esters alone. The invention may be used as a bait or lure within the confines of a trap, or in a bait station, where a toxicant is to be delivered in a food matrix, which yellowjackets take back to the nest, thereby killing the nest. Yellowjackets detect these attractive compounds inside the trap or lure, and become more motivated to enter the device, due to the perceived increased likelihood of finding prey species therein.

There are several ways in which this invention may be practiced. MSA and/or t-2-H may be used in any combination with one or more of the available esters. Several embodiments of the invention, or attractant combinations, are summarized in Table A. Embodiments X through XII refer to formulas based on any butyric acid ester or combination of esters (other than OB+HB) capable of attracting yellowjackets.

TABLE A
Summary of various combinations which may be used in the invention

| | MSA | t-2-H | MSA plus t-2-H |
|---|---|---|---|
| heptyl butyrate | I | II | III |
| octyl butyrate | IV | V | VI |
| heptyl butyrate plus | VII | VIII | IX |
| octyl butyrate | | | |
| ESTER(S) | X | XI | XII |

Yellowjackets trapped during this study were predominately those of the species Vespula pensylvanica, and to a much lesser degree V. vulgaris. However, the invention is anticipated to work with any Vespula species known to be attracted to heptyl butyrate and like compounds, including V. vulgaris, V. atropilosa, V. sulphurea, V. vidua, V. squamosa, V. flavopilosa, and to a lesser extent V. maculifrons and V. germanica, and other minor or non-pest species of yellowjackets. Data has been collected to support the embodiments IV, V, and VI, and shows a strong enhancement of attractiveness to V. pensylvanica, due to both MSA and t-2-H in combination with heptyl butyrate and octyl butyrate. Preliminary testing of I, II and III suggest that the same effect is true for heptyl butyrate in combination with MSA and/or t-2-H, and for combinations of heptyl butyrate and octyl butyrate. Other plant volatiles from leaf-damaged plants have not been tested extensively as attractants for yellowjackets. However, it is anticipated that other kairomones (plant volatiles) will have a similar effect in attracting yellowjackets, as all kairomones produced by plants have a common or similar function. The invention also anticipates the use of other esters, including those listed by Davis, MacDonald, and McGovern, Eddy, and other researchers.

In a preferred embodiment (III) of the invention, MSA and t-2-H are added (0.5-10% each by weight) to heptyl butyrate to make a homogeneous solution. The solution is added to a cotton ball, cotton pad, wick, a similar absorbent material of any composition with the ability to absorb the attractant, or any other dispensing means used to create a volatile blend of the components, and placed within a suitable trap or bait station as a means of attracting yellowjackets to the trap or bait station. The invention may also be practiced by adding the solution directly to a trap with no absorbent material, or may be presented in any other way that is commonly used for deploying chemical attractants in traps, bait stations, or other devices to which yellowjackets are to be attracted.

In a most preferred embodiment of the invention, the two minor components, t-2-H and MSA are added to a combination of heptyl butyrate and octyl butyrate, where heptyl and octyl are in equal concentrations, to make a dilute solution (<0.5%-10% each of t-2-H and MSA) in the esters.

The optimal range of concentrations of the minor components is not precisely known. However, functionally useful concentrations of each minor component are between 0.1% and 20% for use in combination with esters of butyric acid for the purpose of making attractant lures or baits for yellowjackets.

Several experiments were performed to determine the relative attractiveness of heptyl butyrate, octyl butyrate and a 1:1 mixture of the two esters. In an initial experiment, one trap each containing octyl butyrate, heptyl butyrate, or a 1:1 mixture of the two esters, was placed around the perimeter of the north lawn of the Lawrence Hall of Science, University of California, Berkeley. After approximately 1 month, the yellowjackets in each trap were collected and counted. Trapped yellowjackets were found to be primarily of the species Vespula pensylvanica. The results are shown below in Table 1:

TABLE 1
6/15-7/21, LHS NL

| Composition | # YJ caught |
|---|---|
| octyl | 36 |
| heptyl | 148 |
| octyl + heptyl | 168 |

A second experiment was set up at the Lawrence Hall of Science upper patio, placing 4 sets of the three treatments randomly around the patio, a total of 12 traps. One trap containing octyl butyrate was lost and not counted. After twenty days, the total numbers of yellowjackets caught for each of the treatments is shown in table 2 below:

TABLE 2
7/21-8/10/05, LHS UP

| Composition | Total # YJ |
|---|---|
| octyl | 145 |
| Heptyl + octyl | 146 |
| heptyl | 235 |

A third trial was performed in the same location using a total of 12 traps. There were 4 repetitions of each treatment presented. The total number of yellowjackets caught per each treatment is shown in table 3:

TABLE 3
8/11-9/7/05, LHS UP

| | Avg catch per | |
|---|---|---|
| total YJ | trap | composition |
| 320 | 80 | heptyl + octyl |
| 134 | 45 | octyl |
| 242 | 61 | heptyl |

Total numbers of yellowjackets caught for all trials are given below:

| | |
|---|---|
| Octyl | 315 |
| Heptyl | 625 |
| Octyl + Heptyl | 634 |

The trial from Jul. 21-Aug. 10, 2005 cannot be assumed to be an anomaly. However, in related experiments not cited here the combination of heptyl butyrate and octyl butyrate consistently appears to be as good or better at attracting yellowjackets than heptyl butyrate alone. If all of the results from the three experiments are totaled, the combination of octyl and heptyl butyrates is equal to or better than heptyl butyrate alone. Octyl butyrate by itself is an inferior attractant to heptyl butyrate, based on the experimental data.

Any combination of esters known to be attractive to yellowjacket species may be used in the present invention. Davis, MacDonald, McGovern and Eddy (vide supra) have described these compounds in detail.

Several field experiments were run to determine the effect of adding the kairomones trans-2-hexenol and/or methyl salicylate (Component (A)) to heptyl butyrate, octyl butyrate or a combination of the two esters (Component (B)). Most of the data reported is from experiments using octyl butyrate as Component (B). A recent experiment comparing octyl butyrate, heptyl butyrate and a combination of the two, along with the added kairomones, was abandoned, due to the traps having been improperly serviced during the experiment.

In one experiment, octyl butyrate (OB) was compared with OB containing 1% methyl salicylate (MSA). Six traps were placed at the Lawrence Hall of Science Back Plaza on Jul. 21, 2005. Three of the traps were baited with octyl butyrate alone. The other three were baited with the mixture of 1% methyl salicylate in octyl butyrate. Each of the traps contained 8ml of attractant dispensed on a cotton pad, which was placed inside the trap. The traps were collected on Sep. 8, 2005, and the yellowjackets counted. Results are presented in table 4. Fifty two (52) Yellowjackets were caught in the traps containing OB+MSA, whereas no yellowjackets were caught using octyl butyrate alone in this test.

TABLE 4
Aug. 11, 2009-Sep. 8, 2005
LHS Back Plaza
Octyl butyrate (OB) vs. OB + methyl salicylate (MSA)

| Trap Number | Treatment | # of YJ | Totals |
|---|---|---|---|
| 37 | OB | 0 | 0 |
| 38 | OB | 0 | |
| 39 | OB | 0 | |
| 40 | OB + MSA | 37 | 52 |
| 41 | OB + MSA | 15 | |
| 42 | OB + MSA | 0 | |

In another experiment conducted at the Strawberry Baseball Diamonds, octyl butyrate was compared to octyl butyrate+t-2-hexenol, where the trans-2-hexenol was present in 1% concentration by weight. Table 5 shows the results for six traps, 3 containing octyl butyrate (OB) alone, and 3 containing octyl butyrate+t-2-hexenol (t-2-H, 1%). For each treatment, 8 ml of attractant was used. The traps were collected and counted after 27 days. The total number of yellowjackets caught in the three traps with octyl butyrate alone is 113. A total of 170 yellowjackets were caught in the three traps baited with octyl butyrate +t-2-hexenol.

TABLE 5
Aug. 11, 2005-Sep. 8, 2005
Strawberry Baseball Diamonds
Octyl butyrate vs. Octyl butyrate + trans-2-hexen-1-ol

| | | | | Total YJ per |
|---|---|---|---|---|
| Trap # | Treatment | # of YJ | | Treatment |
| 49 | Octyl (OB) | 34 | | |
| 50 | OB | 41 | OB | 113 |
| 51 | OB | 38 | OB + t-2-H | 170 |
| 52 | OB + t-2-H | 43 | | |
| 53 | OB + t-2-H | 44 | | |
| 54 | OB + t-2-H | 83 | | |

In a separate experiment, a mixture of octyl butyrate and the two kairomones methyl salicylate (MSA) and trans-2-hexenol (t-2-H), where the two kairomones were each present in 1% by weight quantities, was tested against octyl butyrate alone. Three repetitions of each treatment were tested in yellowjacket traps placed around the Lawrence Hall of Science North Lawn on Jul. 21, 2005. Each lure contained 8 ml of attractant. The traps were collected and the yellowjackets removed and counted on Aug. 11, 2005. Table 6 shows the results. A total of 40 yellowjackets were caught using the combination OB+MSA+t-2-H, whereas only 31 yellowjackets were caught in traps baited with OB alone.

TABLE 6
Jul. 21, 2005-Aug. 11, 2005
Lawrence Hall of Science North Lawn
Octyl butyrate (OB) vs. OB + MSA + t-2-H

| Trap Number | Treatment | # YJ | Totals |
|---|---|---|---|
| 43 | OB | 5 | |
| 44 | OB | 6 | 31 |
| 45 | OB | 20 | |
| 46 | OB + MSA + t-2-H | 12 | |
| 47 | OB + MSA + t-2-H | 11 | 40 |
| 48 | OB + MSA + t-2-H | 17 | |

Several other experiments were performed using various combinations of heptyl butyrate/octyl butyrate and kairomones methyl salicylate and trans-2-hexenol, however no meaningful statistical data were collected due to some of the traps in each experimental set being tampered with or lost. Casual observations, however supported the same effect observed for octyl butyrate, when heptyl butyrate and/or octyl butyrate were blended with the kairomones.

It can be seen from the data that there is an enhancement of attractancy of octyl butyrate (OB) to yellowjackets, due to the addition of either or both of methyl salicylate (MSA) and trans-2-hexen-1-ol (t-2-H) in 1% concentrations in OB. When neat (unadulterated) OB was compared to OB spiked with 1% MSA, the traps containing MSA caught 52 yellowjackets, while OB caught none. This was an unexpected result. Normally one would expect to find at least a few yellowjackets caught by the OB baited traps. The attractancy of MSA to yellowjackets may be stronger than predicted.

Octyl butyrate plus 1% trans-2-hexen-1-ol showed a dramatic improvement over octyl butyrate alone, catching 170 yellowjackets vs. octyl butyrate alone, with only 113 YJ caught. This shows a clear enhancement (50% more yellowjackets caught) of attractancy of the combination of OB+t-2-H over the ester (OB) alone.

Finally, when both kairomones methyl salicylate and trans-2-hexenol are used together at 1% concentrations in octyl butyrate, an enhancement is also observed with respect to octyl butyrate alone. The data shows that in this experiment a total of 40 yellow jackets were caught in the three traps containing OB+MSA+t-2-H, while only 30 were caught in OB baited traps. Thus, there is a 33% improvement in attractancy for the combination attractant OB+MSA+t-2-H in this experiment.

Similar compositions of kairomones with heptyl butyrate, and combinations of heptyl butyrate and octyl butyrate show the same effects, an increase of attractiveness of the known esters by addition of kairomones methyl salicylate and/or trans-2-hexenol. The invention provides an improved yellowjacket attractant over previously known attractants. The current invention may be used in any type of yellowjacket trap or other insect trap, using any known dispensing means. The invention may also be practiced by using the attractant ester(s)/kairomone(s) blends and any known dispensing means to lure yellowjackets to a bait station, where bait may be formulated to contain a slow acting toxicant, which may then be carried back to the nest, effecting control of the nest. The individual components of the invention do not need to be mixed together, as long as a volatile blend of the active components in useful proportions can be presented via some type of dispensing means. Further embodiments of the invention will be obvious to a competent practitioner of the art.

I claim:

1. An attractant composition for yellowjackets comprising (A) a kairomone or mixture of kairomones, and (B) an ester of butyric acid or mixture of esters of butyric acid, wherein said composition is presented as a mixture of vapors of the components.

2. The composition of claim 1, wherein component (A) comprises trans-2-hexenol.

3. The composition of claim 1, wherein component (A) comprises methyl salicylate.

4. The composition of claim 1, wherein component (A) comprises trans-2-hexenol and methyl salicylate.

5. The composition of claim 2, wherein component (B) comprises heptyl butyrate.

6. The composition of claim 2, wherein component (B) is a mixture of heptyl butyrate and another ester of butyric acid.

7. The composition of claim 4, wherein component (B) is a mixture of heptyl butyrate and octyl butyrate.

8. The composition of claim 4, wherein trans-2-hexenol and methyl salicylate are each present at a concentration of 0.5-10%.

9. The composition of claim 1, wherein component (A) is present in the composition in an amount ranging from about 0.1% to about 20% of the total mass.

10. A method for attracting yellowjackets, said method consisting of providing a dispensing means which releases a vapor blend of components (A) and (B) which act together to attract said yellowjackets, component (A) comprising a kairomone or mixture of kairomones, and component (B) comprising an ester or esters of butyric acid.

11. The method of claim 10, wherein component (A) comprises trans-2-hexenol.

12. The method of claim 10, wherein component (A) comprises methyl salicylate.

13. The method of claim 10, wherein component (A) comprises trans-2-hexenol and methyl salicylate.

14. The method of claim 10, wherein component (B) comprises heptyl butyrate.

15. The method of claim 10, wherein component (B) is a mixture of heptyl butyrate and another ester of butyric acid.

16. The method of claim 13, wherein component (B) comprises heptyl butyrate and octyl butyrate.

17. The method of claim 13, wherein trans-2-hexenol and methyl salicylate are present in said dispenser means at a concentration of about 0.5% to about 10% of total mass.

18. The composition of claim 1, wherein component (A) is present in the composition in an amount ranging from about 0.1% to about 20% of the total mass.

19. The method of claim 10, wherein separate dispenser means are used for each component (A) and (B).

20. The method of claim 10, wherein attracted yellowjackets are lured to a bait station which includes said dispenser means.

21. The method of claim 10, wherein attracted yellowjackets are trapped within a trapping means for yellowjackets which includes said dispenser means.
